(19) United States
(12) Patent Application Publication
(10) Pub. No.: US 2008/0211125 A1
(43) Pub. Date: Sep. 4, 2008

(54) Method for Controlling a Container Blow Molding Machine to Correct Anomalies in Material Distribution

(75) Inventors: Mikael Derrien, Octeville sur Mer (FR); Dominique Martin, Octeville sur Mer (FR); Christophe Bunel, Octeville sur Mer (FR)

Correspondence Address: YOUNG & THOMPSON, 209 Madison Street, Suite 500, ALEXANDRIA, VA, 22314, US

(73) Assignee: SIDEL PARTICIPATIONS, OCTEVILLE SUR MER (FR)

(21) Appl. No.: 11/884,579

(22) PCT Filed: Jan. 9, 2006
(86) PCT No.: PCT/EP2006/050094

§ 371 Date: Aug. 17, 2007

(30) Foreign Application Priority Data
Feb. 17, 2005 (FR) 0550449

(51) Int. Cl. B29C 49/78

(52) U.S. Cl. 264/40.4

(57) ABSTRACT

The invention concerns a method for controlling a blow molding machine (18) for making containers (12). The machine (18) comprises a control system (26) and a number of blow molding stations (22) and is characterized in that the control system implements iteratively a control cycle including the following successive phases: a phase of estimating the mass of a significant portion of each container (12); an analysis phase to compare the estimated mass with a reference mass to as to detect mass variations; a correction phase during which the pre-molding and/or drawing and/or blow molding parameters are modified based on the mass variations.

The invention relates to a method of controlling a blow molding machine.

The invention relates more particularly to a method of controlling a blow molding machine for the production of containers, such as bottles, from plastic preforms, of the type in which the machine comprises a control system, a thermal conditioning oven and a blow molding unit comprising several blow molding stations, each station comprising a mold, and of the type in which the preforms arrive at the inlet of the blow molding unit, coming from a thermal conditioning oven, each preform being introduced into a mold where it undergoes an operation to convert it to a container, which includes at least one blowing step until it takes the form of the mold, so as to obtain a flow of containers at the outlet of the machine.

The manufacture of containers, such as plastic bottles by blow molding preforms, is well known.

Before being blown so as to take up the form of a container, the preform undergoes appropriate heat treatment in a thermal conditioning oven. This heat treatment may be relatively sophisticated depending on the characteristics of the container to be obtained.

The preform is then received in a mold containing the impression of the container to be obtained and, during the flowing step, a blowing fluid, generally air at high pressure (typically between 25×10⁵ Pa and 40×10⁵ Pa), is injected via a nozzle into the preform in order to inflate and press the material against the walls of the mold, thereby making it possible to obtain the container.

Preferably, the conversion operation may include a stretching step (also called an elongation step) in which the preform is stretched or elongated by means of a stretching rod that is associated with the mold and is controlled so as to slide toward the bottom of the preform, and/or a preblowing step (typically at a pressure of between 25×10⁵ Pₐ and 40×10⁵ Pa).

The operation of a blow molding machine is relatively complex, in particular because of the large number of parameters liable to influence the quality of the containers obtained.

In general, the fine-tuning of the machine is carried out manually by a technician, who performs tests by acting on the various operating parameters of the machine until the correct quality of container is output by the machine. It is in particular during the fine-tuning that it is determined whether the conversion operation has to include a stretching step and/or a preblowing step, and likewise the sequencing of the instants when the various steps carried out start.

Although the quality of the containers may be correct during the initial fine-tuning of the machine, the adjustments made by the technician may however need to be re-examined during operation of the machine in production mode.

This re-examination requirement may arise when parameters external or internal to the machine change, for example when the ambient temperature and pressure conditions change, or because of wear of certain components of the machine, or else when characteristic parameters of the preforms (such as intrinsic viscosity, quality of the resin, moisture pickup by the material, initial temperature) change during production for various reasons.

These phenomena, when they are detected belatedly, may result in a drift in quality, or even lead to loss of containers.

In addition, it is necessary to carry out a new fine-tuning phase, which may require stopping the machine.

Document DE-A-10 116 665 partly solves these problems by proposing a method of controlling a blow molding machine in which machine operating parameters, such as the heating profile and/or the molding parameters, are adjusted according to the measured wall thickness of the containers.

However, the quality of the containers produced using this method may still drift. This is because containers having substantial defects, in the distribution of material in the walls, may pass through the control systems of the process.

The present invention aims to remedy these drawbacks by proposing a more stable method of manufacturing containers, making it possible to improve the general quality of the containers manufactured.

For this purpose, the invention provides a method of the type described above, characterized in that the control system implements, in an iterative manner, a control cycle comprising the following successive phases:
an estimation phase during which the mass of at least one significant portion of each container is estimated downstream of the machine;
an analysis phase during which the estimated mass is compared with a distribution setpoint so as to detect mass deviations representative of an anomaly or of a drift in the material distribution in the walls of the bottle; and
a correction phase during which at least one of the key parameters of the conversion operation is modified according to the mass deviations so as to correct said mass deviations.

In fact, the Applicant has found that it is more important for certain specified, and therefore significant, portions of the containers to have a given mass rather than a given thickness. This is because the known methods, which consist in determining the thickness, are not completely reliable in that the thickness determination consists in calculating an average wall thickness from a measurement made through a diameter of the container. Now, it may very well be the case that the average value calculated over a diameter is correct if there in fact exists a thickness non-uniformity from one end of the diameter to the other, or even on the periphery, whereas when the mass of a significant portion of the container is correct, in general the container itself is correct.

According to other features of the invention:
the mass is estimated in line, directly in the flow of containers;
during the estimation phase, the mass is estimated by means of a measurement device placed downstream of the machine; the device is an optical device or the device is an ultrasonic device;
the term “significant portion” is understood to mean a portion for which it is important that it contain a given mass of material, and the measurement device estimates the mass of at least one such significant portion of each container. It should be noted that the notion of significant portion may vary from one container to another: thus, for a bottle, a significant portion may be the bottom; another significant portion may be the shoulder; and yet another may be the body (the portion between the shoulder and the bottom). Furthermore, for certain containers that have to have a particular geometry at a given location, it may be advantageous to determine the mass of material at this location, which therefore constitutes a significant portion;
during the analysis phase, the estimated mass is compared with the previous estimates so as to detect repeated mass deviations indicating the existence of a drift and the correction phase is implemented only when a drift is detected;
during the analysis phase, if a drift is detected, the control system determines whether the drift is a local drift, i.e. being due to one or more specified stations, without most of the stations being affected, or whether the drift is an overall drift, i.e. being due to a general malfunction of the machine or to a change in the external parameters which may influence the result of the blowing (such as ambient temperature and atmospheric pressure), and the correction phase is applied to the incriminated station/or stations when the drift is a local drift and to all the stations when the drift is an overall drift;
in the event of a local drift affecting several stations, the control system determines whether the drift is identical over all the affected stations, and applies the same correction to all the stations in question, or whether the drift is different from one affected station to another, and then applies a different appropriate correction;
during the correction phase, in the case of a local drift, the modified parameters are chosen from the local rate of the preblowing, the local instant of the start of preblowing, the local duration of the preblowing, the local pressure of the preblowing, the local instant of the start of stretching and/or the stretching rate when the machine includes a stretching rod, the local instant of the start of blowing, the instant of the start of flushing (an operation consisting in reinjecting air after the actual blowing, in order to cool and solidify the bottom of the container), and the local instant of the start of degassing the container (returning to ambient pressure), and in the case of an overall drift, the modified parameters are chosen from the overall pressure of the preblowing, the rate of the preblowing, the instant of the start of preblowing, the duration of the preblowing, and the overall instant of the start of stretching and/or the stretching rate when the machine includes a stretching rod, the overall instant of the start of blowing and/or the duration of blowing, the overall instant of the start of flushing and/or its duration and the instant of the start of degassing;
during the correction phase, the control system checks that the drift possesses a low enough amplitude to be able to be corrected and, when the drift cannot be corrected, the control system signals the existence of a technical problem in the machine;
when the control system signals the existence of a technical problem due to an uncorrectable local drift on a station, the control system proposes an alternative between:
operating the machine in degraded mode, in which the incriminated station is neutralized;
operating the machine in degraded mode in which the incriminated station is kept in operation; and
stopping the machine;
the control method continuously checks the temperature of each preform at the inlet of the machine, downstream of the oven, which temperature is compared with a setpoint temperature, and when a significant deviation is detected between the measured temperature and the setpoint temperature, the control system signals the existence of a technical problem upstream of the machine; and
in one method of implementation, the temperature check on each preform is at a discrete point; in an alternative method of implementation, the check is an overall check, so that it is the average temperature of each preform that is determined.

Other features and advantages of the invention will become apparent on reading the detailed description that follows but for the understanding of which the reader may refer to the appended drawings in which:

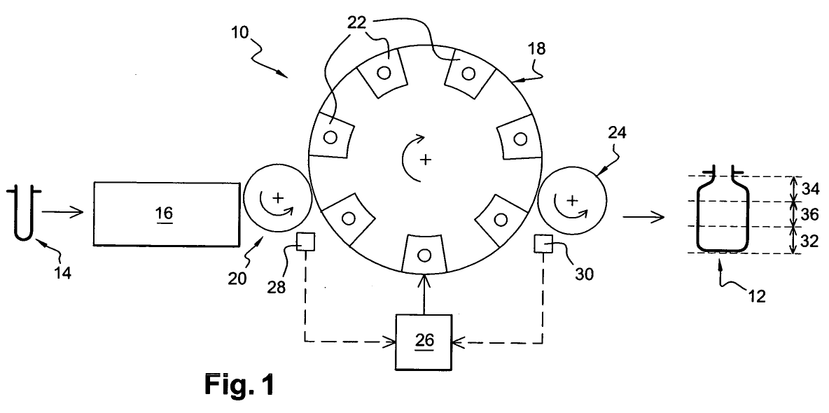

FIG. 1 is a diagram showing an installation for the manufacture of containers, consisting of bottles, by a stretch-blow molding from preforms; and

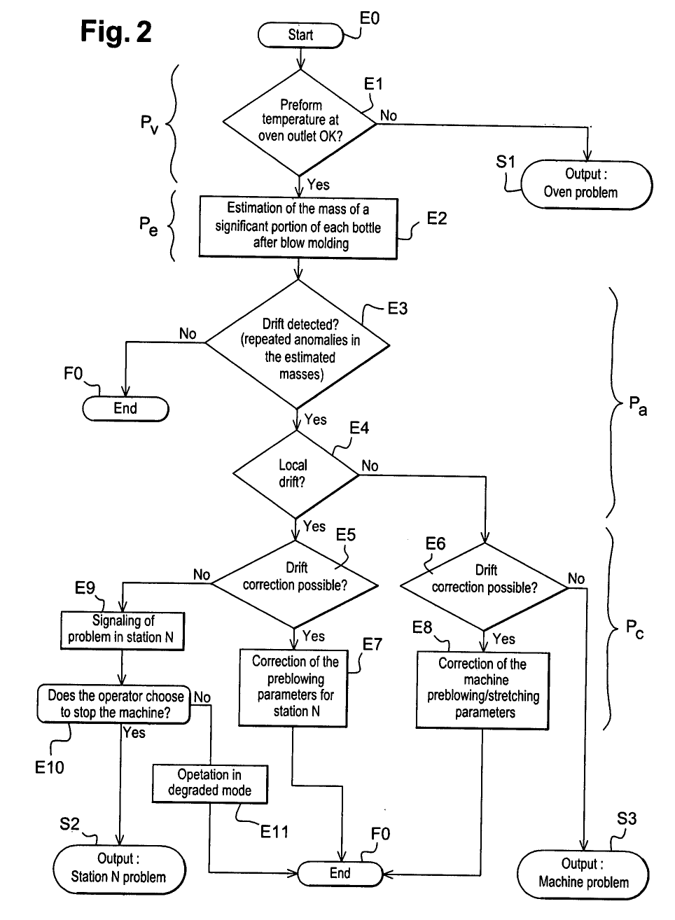

FIG. 2 is a flow chart illustrating the control cycle of the method of controlling the blow molding machine with which the installation of FIG. 1 is equipped, in accordance with the teachings of the invention.

FIG. 1 shows an installation 10 for manufacturing containers 12, here bottles, from plastic preforms 14.

The material used is for example polyethylene terephthalate (PET).

The installation 10 includes a thermal conditioning oven 16, which is continuously fed with a flow of preforms 14 via conveying means (not shown), which oven brings the preforms 14 to an appropriate temperature.

On leaving the oven 16, the heated preforms 14 are transferred into a blow molding machine 18, for example by means of a first transfer wheel 20 so that a continuous flow of preforms 14 feeds the machine 18.

The machine 18 is for example of the rotary type. It comprises a carousel that rotates continuously about its axis and carries, on its periphery, a series of blow molding stations 22.

Each blow molding station 22 comprises a mold and an associated stretching rod.

The machine 18 is controlled by a control system 26.

When a preform 14 arrives at the inlet of the machine 18, it is received in a mold where it undergoes a preblowing operation, a stretching operation and a blowing operation until it takes the complete shape of the mold, so as to obtain a container 12.

A flow of containers 12 is obtained at the outlet of the machine 18.

A second transfer wheel 24 takes hold of the containers 12 output by the machine 18 so as to transfer them to the outlet of the installation 10.

The installation 10 is equipped with a temperature sensor 28, which is placed at the inlet of the machine 18, and with a measurement device 30, here an optical device, which is placed here at the outlet of the machine 18.

In accordance with the method of controlling the machine 18 according to the invention, the control system 26 implements, for each container 12, a control cycle comprising the following successive phases:
an estimation phase Pₑ during which the mass M₀ of at least one significant portion of the container 12 is estimated downstream of the machine 18;
an analysis phase Pₐ during which the estimated mass M₀ is compared with a setpoint mass Mₛₑₜ so as to detect mass deviations ΔM representative of an anomaly in the distribution of material in the walls of the container; and
a correction phase P_{c} during which key parameters of the preblowing operation and/or key parameters of the stretching operation and/or key parameters of the blowing operation proper are modified according to the mass deviations ΔM so as to correct these mass deviations ΔM.

A preferred way of implementing the control method according to the invention, in particular considering the flow chart shown in FIG. 2, which illustrates the control cycle carried out by the control system 26, will now be described in detail.

The control cycle starts with the initial step E0 and continues via the first step E1, which symbolizes a verification phase Pᵥ during which the temperature T₀ of each preform 14 is measured at the inlet of the machine 18, downstream of the oven 16, and is compared with a setpoint temperature Tₛₑₜ.

When a significant temperature deviation ΔT is detected between the measured temperature T₀ and the setpoint temperature Tₛₑₜ, the control system 26 signals the existence of a technical problem in the operation of the oven 16, this being shown symbolically by the first output step S1.

The control cycle is then stopped and the control system 26 is able to stop the entire installation 10 if it is impossible for this temperature deviation ΔT to be rapidly corrected.

If the measured temperature T₀ is within specification, the control cycle continues via the estimation phase Pₑ.

It should be noted that the verification phase Pᵥ may occur at any moment in the control cycle.

The estimation phase Pₑ is represented by the second step E2, during which the mass M₀ of at least one significant portion of the container 12 is measured by means of the measurement device 30.

The measurement device 30 is for example an optical device using sensors (not shown) that measure the transmission of electromagnetic radiation through a specified zone of the walls of the container 12 in order to deduce therefrom the corresponding volume of material and the mass M₀ of this volume.

Such a device 30 is described for example in document US A 2003/0159856.

Alternatively, an ultrasonic measurement device may be used.

Advantageously, the device 30 makes measurements of the mass M₀ in line, that is to say directly in the flow of containers 12, so that it is unnecessary to remove containers 12 from the flow.

In particular, this device 30 makes it possible, if necessary, to take measurements of the mass M₀ continuously on all the containers 12 produced.

However, it is conceivable, although less effective, to make an estimation off line, either automatically, for example with an optical device identical to the device 30 mentioned above, or manually, and then to reinject the measurement data into the machine so that the correction can then be made automatically.

Preferably, the significant portion of the container 12 chosen for the measurement consists of at least one axial portion of the container 12, either the lower end portion 32, which corresponds to the bottom of the container 12, and/or the upper portion 34 which, when the container is a bottle, corresponds to its shoulder, and/or else an intermediate portion 36, which corresponds to the body of the container.

It is also possible to choose, as significant portion, part of one or more of the abovementioned portions 32, 34, 36, such as for example a part having a particular shape (gripping band, spline, etc.) and having to have a predetermined mass of material, failing which the container must be considered as defective.

However, it should be noted that when the container 12 is a bottle, its lower end portion 32 is particularly appropriate for the measurement as this is a zone which is particularly sensitive to material distribution problems.

The mass M₀ of the portion 32, 34, 36 of the container 12 thus constitutes a valve representative of the quality of the material distribution throughout the container 12.

This is because it has been found that, when the mass M₀ of a significant portion 32, 34, 36 corresponds substantially to a setpoint value Mₛₑₜ fixed by the operator of the machine 18, the probability that the material distribution in the walls of the container 12 is good is very high.

Consequently, the existence of a significant mass deviation ΔM between the measured mass M₀ and the setpoint mass Mₛₑₜ reveals the existence of an anomaly in the material distribution in the walls of the container 12.

The estimation phase Pₑ is followed by the analysis phase Pₐ, which starts with the third step E3 shown in FIG. 2, during which the estimated mass M₀ is compared with the previous estimates, that is to say with the masses M₀ measured on the containers 12 produced before that in the course of being checked.

The analysis phase Pₐ thus makes it possible to detect repeated mass deviations ΔM indicating the existence of a drift D in the process for producing the containers 12.

This is because local mass deviations ΔM may occur without being due to a malfunction of the machine 18. Such mass deviations ΔM do not necessarily lead to the correction phase P_{c} being implemented.

The correction phase P_{c} is therefore implemented only when a drift D is detected.

When no drift D is detected, the control cycle is complete, which therefore terminates in the final step F0 in FIG. 2.

When a drift D is detected, the analysis phase Pₐ continues with a fourth step E4 during which the control system 26 determines whether the drift D is a local drift D_{L}, as being due to the malfunction of a specified station 22, or else the malfunction of several stations, without most of the stations being affected, for example a local drift which is the same or different over several stations, or whether the drift D is an overall drift D_{O}, as being due to a general malfunction of the machine 18.

The control system 26 includes for example counting means allowing it to know, for each container 12, on which station 22 it has been manufactured.

After the analysis phase Pₐ, the control system 26 implements the correction phase P_{c}.

The correction phase P_{c} starts here with a prior step E5, E6 during which the control system 26 checks whether the amplitude of the drift D is low enough to be able to be corrected.

This prior step is illustrated in FIG. 2 by the fifth step E5 in the case of a local drift D_{L} and by the sixth step E6 in the case of an overall drift D_{O}.

In the case of a local drift D_{L}, if the correction is possible, the correction phase P_{c} continues with the seventh step E7 during which key parameters of the preblowing operation are modified on the incriminated station 22 (“station N” in FIG. 2) according to the mass deviations ΔM measured during the analysis phase Pₐ.

Furthermore, in the event of a local drift affecting several stations, without however most of the stations being affected, the control system determines whether the local drift is identical over all the stations affected, and applies, during the correction phase, the same correction to all of the stations in question, or whether the drift differs from one affected station to another, and then applies a different appropriate correction.

Preferably in the case of a local drift D_{L}, the control system 26 modifies as a priority the local preblowing rate, that is to say that of the station or stations 22 where a local drift has been detected.

Of course, the control system 26 may modify other parameters, in parallel or instead of the preblowing rate. The control system 26 may for example shift the local instant of the start of the preblowing operation or modify the duration of the preblowing operation, the local pressure of the preblowing, the local instant of the start and/or the rate of the stretching operation, the instant of the start of blowing and/or its duration, the instant of the start of flushing (the operation consisting in reinjecting air after the actual blowing, in order to cool and solidify the bottom of the container), and the local instant of the start of degassing the container (return to ambient pressure).

In the case of an overall drift D_{O}, if the correction is possible the correction phase P_{c} continues with the eighth step E8, during which key parameters of the preblowing operation and/or the stretching operation are modified, on the entire machine 18, depending on the mass deviations ΔM measured during the analysis phase Pₐ. The modifications made here have repercussions on all the stations 22 of the machine.

Preferably, in the case of an overall drift D_{O}, the control system 26 modifies as a priority the preblowing pressure valve.

Of course, the control system 26 may modify other parameters, in parallel or instead of the preblowing pressure. The control system 26 may for example modify the preblowing rate, shift the instant of the start of the preblowing operation, modify the duration of the preblowing operation. The control system 26 may also modify the stretching speed, that is to say the speed at which the stretching rod slides toward the bottom of the bottle 12 as far as its end position, the instant of the start of blowing and/or its duration, the instant of the start of flushing, the instant of the start of degassing, or any other parameter of the actual forming process.

It should be noted that when the mass deviations ΔM are positive, that is to say the mass of the bottom of the bottle 12 is too large, the control system 26 may correct this material distribution anomaly by increasing the preblowing rate and/or by advancing the instant of the start of preblowing and/or reducing the duration of the preblowing and/or by increasing the preblowing pressure and/or reducing the stretching speed and/or acting appropriately on one or more of the abovementioned parameters (flushing, degassing, etc.).

When the mass deviations ΔM are negative, that is to say when the mass of the bottom of the bottle 12 is insufficient, the control system 26 corrects this material distribution anomaly by modifying the preblowing and/or stretching parameters symmetrically, i.e. in the opposite direction relative to the direction indicated above.

After having carried out the parameter modifications, the control cycle continues as far as the final step F0.

Since the control cycle is implemented iteratively, a new initial step E0 follows the final step F0.

By implementing the control cycle iteratively it is possible, when a drift D is detected, to check whether the modifications made have enabled the drift D to be corrected. If this is not the case, a new correction phase P_{c} will be applied.

When the control system 26 considers that the correction is not possible, it signals the existence of a technical problem in the machine 18.

In the case of a local drift D_{L} unable to be corrected, the control system 26 signals a technical problem in the incriminated station 22, corresponding, in FIG. 2 to the ninth step E9.

Advantageously, the control system 26 may propose, in this case, two alternatives to the operator responsible for operating the machine 18, as illustrated in the tenth step E10 of the flow chart.

The operator may choose between:
stopping the machine 18, thereby stopping the control cycle, as illustrated via the second output step S2; and
operating the machine 18 in degraded mode, as illustrated by the eleventh step E11.

In degraded mode, the incriminated station 22 may be neutralized so that the machine 18 can continue to operate; alternatively, it may be decided to operate the machine in degraded mode while keeping the incriminated station in operation.

For example, a neutralizing device (not shown) upstream of the machine 18 may be provided, which ejects the preforms 14 intended for the incriminated station 22.

In degraded mode, the control cycle continues as far as the final step F0.

In the case of an overall drift D_{O} unable to be corrected, the control system 26 signals a technical problem relating to the entire machine, which corresponds in FIG. 2 to the third output step S3.

The control system 26 then stops the machine 18.

Of course, the technical information about the operation of the machine 18, obtained during the control cycle, may be used by the control system 26 for diagnostic purposes, especially for helping to solve possible technical problems detected in the machine 18.

1. A method of controlling a blow molding machine (18) for manufacturing containers (12) from plastic preforms (14), of the type in which the machine (18) comprises a control system (26) and several blow molding stations (22), each station (22) comprising a mold, and of the type in which the flow of preforms (14) arrives at the inlet of the machine (18), coming from a thermal conditioning oven (16), each preform (14) being received in a mold in which it undergoes a container conversion operation, which includes at least one blowing step until the preform takes the form of the mold, so as to obtain a flow of containers (12) at the outlet of the machine (18),
characterized in that the control system (26) implements, in an iterative manner, a control cycle comprising the following successive phases:
an estimation phase (Pₑ) during which the mass (M₀) of at least one significant portion of each container (12) is estimated downstream of the machine (18);
an analysis phase (Pₐ) during which the estimated mass (M₀) is compared with a setpoint mass (Mₛₑₜ) so as to detect mass deviations (ΔM) representative of an anomaly or of a drift in the material distribution in the walls of the bottle (12); and
a correction phase (P_{c}) during which at least one of the key parameters of the conversion operation is modified according to the mass deviations (ΔM) so as to correct said mass deviations (ΔM).

2. The method as claimed in claim 1, characterized in that the mass (M₀) is estimated in line, directly in the flow of bottles (12).

3. The method as claimed in claim 1, characterized in that the mass (M₀) is estimated off line.

4. The method as claimed in claim 3, characterized in that the mass (M₀) is estimated manually.

5. The method as claimed in claim 1, characterized in that, during the estimation phase (Pₑ), the mass (M₀) is estimated by means of a measurement device (30) placed downstream of the machine (18).

6. The method as claimed in claim 5, characterized in that the measurement device (30) is an optical device.

7. The method as claimed in claim 1, characterized in that the significant portion (32, 34, 36) from which the mass (M₀) is estimated is chosen from the lower end portion (32) of the container (12), which corresponds to its bottom, and the upper portion (34) of the container, which corresponds to its shoulder, and an intermediate portion (36) between the portions (32, 34).

8. The method as claimed in claim 1, characterized in that, during the analysis phase (Pₐ), the estimated mass (M₀) is compared with the previous estimates so as to detect repeated mass deviations (ΔM) indicating the existence of a drift (D) and in that the correction phase (P_{c}) is implemented only when a drift (D) is detected.

9. The method as claimed in claim 8, characterized in that, during the analysis phase (Pₐ), if a drift (D) is detected, the control system (26) determines whether the drift (D) is a local drift (D_{L}), as being due to the malfunction of a specified station (22), or whether the drift (D) is an overall drift (D_{O}), as being due to a general malfunction of the machine (18), and in that the correction phase (P_{c}) is applied to a single station (22) when the drift (D) is a local drift (D_{L}) and to all the stations (22) when the drift (D) is an overall drift (D_{O}).

10. The method as claimed in claim 9, characterized in that when the control system (26) determines that several stations are affected by a local drift (D_{L}), it determines whether the local drift is identical on all the stations affected, and applies the same correction to all the stations in question, or whether the drift is different from one affected station to another, and then applies a different appropriate correction.

11. The method as claimed in claim 9, characterized in that, during the correction phase (P_{c}), in the case of a local drift (D_{L}), the modified parameters are chosen from the local rate of the preblowing, the local instant of the preblowing, the local duration of the preblowing, the local pressure of the preblowing, the local instant of the start of stretching and/or the stretching rate when the machine includes a stretching rod, the instant of the start of blowing and/or its duration, the instant of the start of flushing, and the local instant of the start of degassing the container, and in the case of an overall drift (D_{O}), the modified parameters are chosen from the overall pressure of the preblowing, the overall rate of the preblowing, the overall instant of the start of preblowing, the overall duration of the preblowing, and the overall stretching rate and the overall instant of the start of blowing and/or its duration and the overall instant of the start of flushing and the overall instant of the start of degassing.

12. The method as claimed in claim 11, characterized in that, during the correction phase (P_{c}), the control system (26) checks that the drift (D) possesses a low enough amplitude to be able to be corrected and in that, when the drift (D) cannot be corrected, the control system (26) signals the existence of a technical problem in the machine (18).

13. The method as claimed in claim 12, characterized in that, when the system signals the existence of a technical problem due to an uncorrectable local drift (D_{L}) on a station (22), the control system (26) proposes an alternative between:
operating the machine (18) in degraded mode, in which the incriminated station (22) is neutralized;
operating the machine (18) in degraded mode in which the incriminated station (22) is kept in operation; and
stopping the machine (18).

14. The method as claimed in claim 1, characterized in that the control cycle includes a verification phase (Pᵥ) during which the temperature (T₀) of each preform (14) is measured at the inlet of the machine (18), downstream of the oven (16), and is compared with a setpoint temperature (Tₛₑₜ) and in that, when a significant deviation (ΔT) is detected between the measured temperature (T₀) and the setpoint temperature (Tₛₑₜ), the control system (26) signals the existence of a technical problem upstream of the machine (18).
